(19) United States
(12) Patent Application Publication
(10) Pub. No.: US 2024/0075974 A1
(43) Pub. Date: Mar. 7, 2024

(54) Stroller System

(71) Applicant: Michael Noel, Fords, NJ (US)

(72) Inventor: Michael Noel, Fords, NJ (US)

(21) Appl. No.: 18/458,839

(22) Filed: Aug. 30, 2023

Related U.S. Application Data
(60) Provisional application No. 63/374,195, filed on Aug. 31, 2022.

(51) Int. Cl. B62B 5/00; B60H 1/00; B60Q 3/80; B62B 7/04; B62B 9/00; B62B 9/14

(52) U.S. Cl. CPC B62B 5/0076; B60H 1/00785; B60H 1/00821; B60Q 3/80; B62B 5/0036; B62B 5/0053; B62B 5/0056; B62B 7/04; B62B 9/005; B62B 9/14; B62B 2204/00

(57) ABSTRACT

A stroller system includes a stroller frame, a plurality of wheels connected to the stroller frame, a stroller seat attached to the stroller frame, a motor mounted on the stroller frame and configured to drive at least one of the plurality of wheels, a power source configured to supply power to the motor, and a controller configured to control the and thereby the movement of the stroller system.

### FIELD OF THE INVENTION

The present invention relates generally to strollers. More specifically, the present invention is a stroller system that provides enhanced safety and comfort to riders.

### BACKGROUND OF THE INVENTION

Baby strollers are a necessity for many households. While there is a variety of strollers in the market, those strollers are all similar to each other and do not try to facilitate user's experience with electronics. Many issues arise such as safety, monitoring, or notification since the baby has many needs. For example, care providers may not able to grasp the baby's condition at all time, especially when the crib is closed. Moreover, temperature regulation is always an issue, since baby strollers do not have such functions.

Therefore, it is an objective of the present invention to provide a stroller system which overcomes the problems set forth above. The present invention is a simple apparatus that allows a user to collect water spills on the floor in a convenient and easy manner.

### SUMMARY OF THE INVENTION

The present invention discloses a stroller system. The stroller system includes a stroller frame, a plurality of wheels connected to the stroller frame, a stroller seat attached to the stroller frame, a motor mounted on the stroller frame and configured to drive at least one of the plurality of wheels, a power source configured to supply power to the motor, and a controller configured to control the and thereby the movement of the stroller system.

One or more of the following features may be included. The stroller system may further comprise a generator connected to the plurality of wheels. The generator is further connected to the power source to recharge the power source. The stroller system may further comprise a pressure sensor positioned on a bottom portion of the stroller seat. The stroller system may further comprise a humidity sensor positioned on a sidewall portion of the stroller seat to detect an interior humidity of the stroller seat. The stroller system may further comprise a temperature sensor positioned on the sidewall portion of the stroller seat to detect an interior temperature of the stroller seat. The stroller system may further comprise an air circulating device positioned on the sidewall portion of the stroller seat. The air circulating device is configured to circulate cool or hot air into the stroller seat. The controller may be further configured to control the air circulating device based on at least one of measurement results of the pressure sensor, humidity sensor, and temperature sensor. The stroller system may further comprise a plurality of interior lights positioned on the sidewall portion of the stroller seat. The controller may be further configured to control the plurality of interior lights according to a measurement result of the pressure sensor. The stroller system may further comprise an impact sensor for detecting an impact of a collision. The stroller system may further comprise a collision protection device disposed in the stroller seat. The controller may be further configured to control the collision protection device to operate upon detecting the impact of the collision. The stroller system may further comprise a GPS unit to determine a current location of the stroller system. The controller may be further configured to control the air circulating device based on the current location of the stroller system. The stroller system may further comprise an ambient light sensor disposed on the stroller frame. The stroller system may further comprise a plurality of exterior lights. The controller may be further configured to turn on or off the plurality of exterior lights according to a measurement result of the ambient light sensor. The stroller system may further comprise a canopy disposed on the stroller seat and a touch sensitive screen placed underneath the canopy. The controller may comprise a processor and a wireless communication unit.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the present invention.

FIG. 2 depicts another perspective view of the present invention.

FIG. 3 depicts another perspective view of the present invention.

FIG. 4 depicts another perspective view of the present invention.

FIG. 5 depicts a block diagram of the components of the present invention.

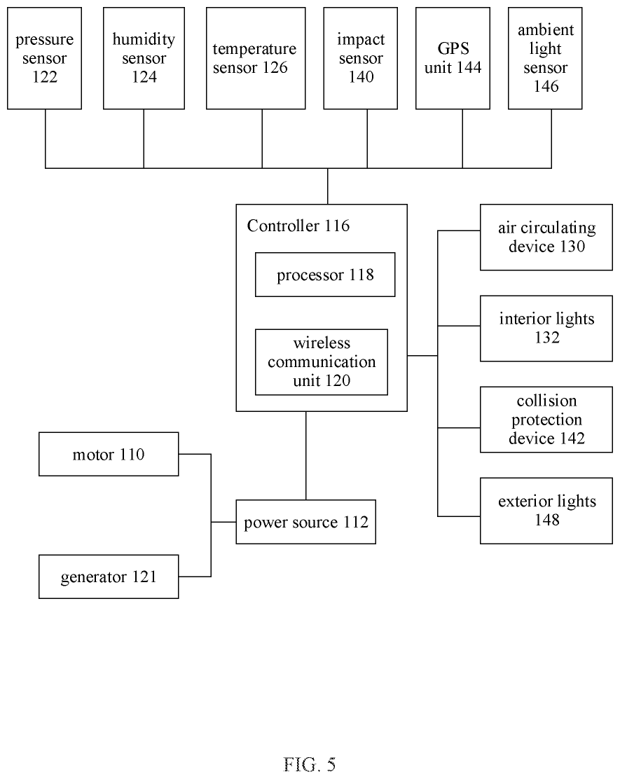

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of strollers, embodiments of the present disclosure are not limited to use only in this context.

The present invention is a stroller system. It is an aim of the present invention to provide a stroller system that is capable of monitoring the baby's condition. It is another aim of the present invention to provide a stroller system that is able to control the equipped electronics using a controller or a portable device. It is another aim of the present invention to provide a stroller system with enhanced safety features.

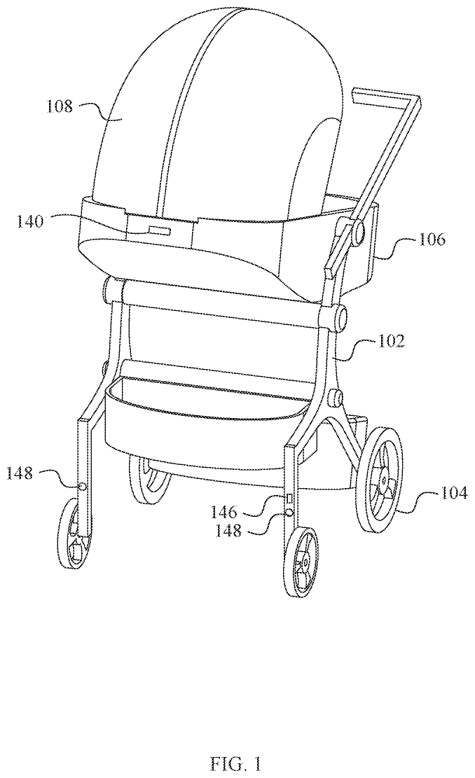

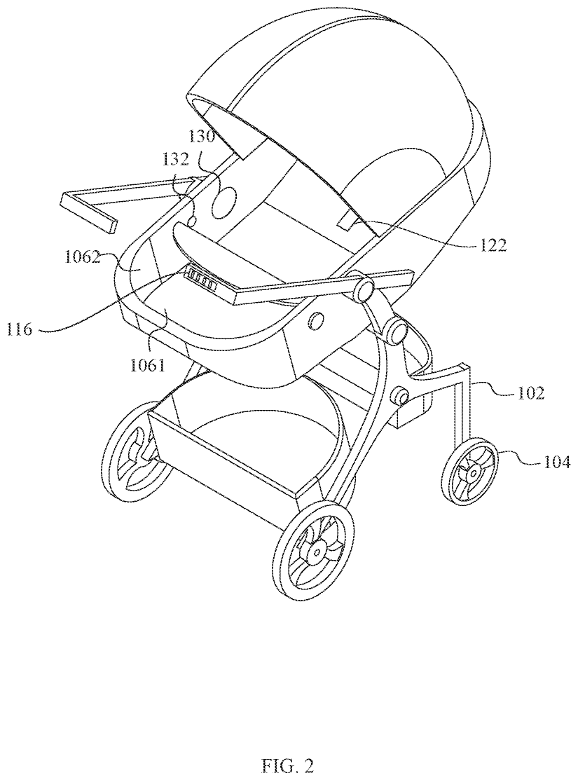

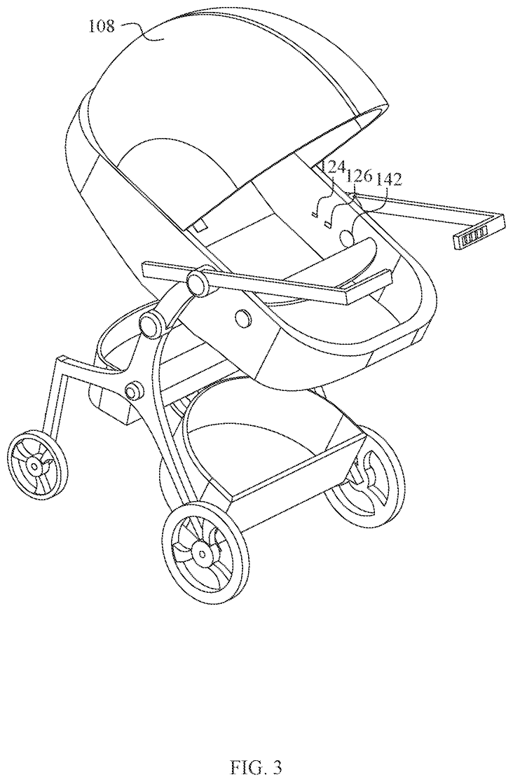

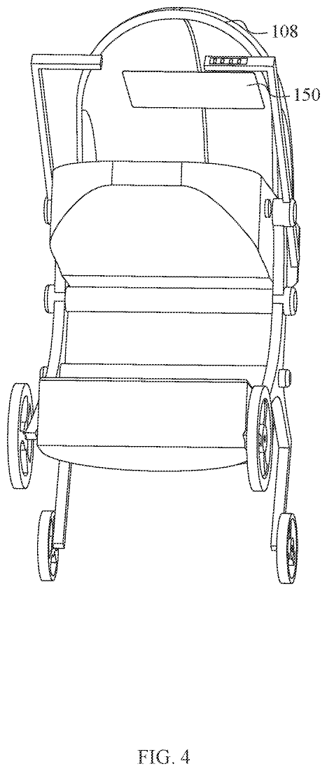

Referring now to the figures of the present disclosure. FIGS. 1-4 are perspective views of the present invention. The stroller system of the present invention comprises a stroller frame 102, a plurality of wheels 104, a stroller seat 106, a motor 110, a power source 112, and a controller 116.

The stroller frame 102 is configured to accommodate the stroller seat 106 and one or more components of the stroller system. It should be noted that the stroller frame 102 can be of any shape, size, material, features, type or kind, orientation, location, quantity, components, and arrangements of components that would allow the present invention to fulfill the objectives and intents of the present invention. In the illustrated embodiment, the stroller frame 102 is configured as a base to hold the plurality of wheels 104. The plurality of wheels 104 may be attached to the stroller frame 102 via a swinging mechanism. The swinging mechanism comes in a pair in the present embodiment. The swinging mechanism allows the plurality of wheels 104 to recline to a certain degree according to the rider's condition.

The plurality of wheels 104 are connected to the stroller frame 102 to support the stroller frame 102 and provide mobility to the stroller system of the present invention. In one embodiment, at least one of the plurality of wheels 104 can swivel for improved maneuverability. In a preferred embodiment, at least one of the plurality of wheels 104 can be locked to impede rotation and thus prevent the stroller system from moving. Preferably, the back wheels are lockable by the user. The plurality of wheels 104 may be made of any suitable material, such as rubber or plastic.

The stroller seat 106 is attached to the stroller frame 102 and is configured to accommodate a rider. It should be noted that the stroller seat 106 can be of any shape, size, material, features, type or kind, orientation, location, quantity, components, and arrangements of components that would allow the present invention to fulfill the objectives and intents of the present invention. In one embodiment, the stroller seat 106 comprises a bottom portion 1061 and a sidewall portion 1062. The bottom portion 1061 and the sidewall portion 1062 form a compartment for the rider. In an embodiment where the stroller seat 106 further comprises a canopy 108, the bottom portion 1061, sidewall portion 1062, and the canopy 108 together form an enclosed compartment for the rider.

The motor 110 is mounted on the stroller frame 102 and configured to drive at least one of the plurality of wheels 104 so as to move the stroller system. In one embodiment, the motor 110 is an electric motor. In a preferred embodiment, the motor 110 is a direct current (DC) electric motor. The motor 110 may drive only the rear wheels of the stroller system, reserving the front wheels for steering. However, alternatively, the motor 110 may drive only the front wheels of the stroller system. In another embodiment, the motor 110 drives both the rear and front wheels, or a combination thereof.

The power source 112 is configured to supply power to the motor 110 and/or other electrical components of the present invention. The power source 112 could be any suitable power source, such as but not limited to rechargeable batteries, solar cells, or any other such reusable power source. In one embodiment, the power source 112 may further comprise a retractable power cord that can be plugged into an electrical outlet in order to recharge the power source 112. In some embodiments of the present invention, the power source 112 is removable from the stroller so that it can be recharged at a location remote from the stroller itself, whereafter it can be reconnected to supply power to the motor 110 and various electrical components of the present invention.

The controller 116 is configured to control the electrical components of the present invention. For example, the controller 116 may control the 100 and thereby the movement of the stroller system. The controller 116 could be any device that is operable to receive input, send output, process the input or output, or perform other suitable operations for a component of the stroller system of the present invention. For instance, the controller 116 may include but not limited to touchscreen, buttons, switches, transducer, or any other suitable device. In a preferred embodiment, the controller 116 may comprise a processor 118 and a wireless communication unit 120. The processor 118 could be any computing device configured to control the operation of one or more components of the stroller system. The processor 118 may be a programmable logic device, a microcontroller, a microprocessor, or any suitable combination thereof. The processor 118 includes any hardware or software that operates to control and process information received by a component of the stroller system. The processor 118 allows the stroller system to automatically control the electrical components based on gathered information. The wireless communication unit 120 is used for wirelessly communicating gathered information to a remote device (such as a user device, a computing cloud, etc.) and receiving command signals from the remote device. The communication may be completed via any means of wireless connection known in the prior art, such as Bluetooth, Wi-Fi, etc.

In one embedment, the present invention may further comprise a generator 121 which acts as an energy-harvesting device. The generator 121 is connected to the plurality of wheels 104 to harvest kinetic energy from the plurality of wheels 104 while the stroller system decelerates and convert the kinetic energy into electricity. The generator 121 is further connected to the power source 112 to recharge the power source 112.

In a preferred embodiment, the stroller system of the present invention further comprises a pressure sensor 122 positioned on the bottom portion 1601 of the stroller seat 106. The measurement result of the pressure sensor 122 may be employed to determine whether the stroller seat 106 is occupied by an occupant and/or whether the occupant is asleep or awake. In one embodiment, the stroller system of the present invention comprises a humidity sensor 124 positioned on the sidewall portion 1062 of the stroller seat 106 to detect an interior humidity of the stroller seat 106. Preferably, the interior humidity may be used to determine if the baba has a soiled diaper. In one embodiment, the stroller system of the present invention further comprises a temperature sensor 126 positioned on the sidewall portion 1062 of the stroller seat 106 to detect an interior temperature of the stroller seat 106. In one embodiment, the stroller system further comprises an air circulating device 130 positioned on the sidewall portion 1062 of the stroller seat 106. The air circulating device 130 is configured to circulate cool or hot air into the stroller seat 106. Specifically, the air circulating device 130 may connect to an air source, such as a heated or cold fan, so as to modify the interior temperature and/or the interior humidity of the stroller seat 106. The air circulating device 130 may be controlled manually or remotely. Preferably, the controller 116 is configured to control the air circulating device 130 based on at least one of measurement results of the pressure sensor 122, humidity sensor 124, and temperature sensor 126, i.e., whether the occupant is asleep, the interior temperature, and the interior humidity. In one embodiment, the stroller system further comprises a plurality of interior lights 132 positioned on the sidewall portion 1062 of the stroller seat 106. The plurality of interior lights 132 may also be controlled manually or remotely. However, it is preferred that the controller 116 is further configured to control the plurality of interior lights 132 according to a measurement result of the pressure sensor 122. For example, if it is determined that the occupant is asleep, the controller 116 may control the plurality of interior lights 132 to turn off.

In one embodiment, the stroller system further comprises an impact sensor 140 for detecting an impact of a collision. Moreover, the stroller system further comprises a collision protection device 142 disposed in the stroller seat 106. The collision protection device 142 is configured to deploy when the collision is detected. The collision protection device 142 could be any suitable device that can protect the occupant from injury during the collision. For example, the collision protection device 142 may be an airbag. In another example, the collision protection device 142 is a device that stores gel- or foam-like material. When the collision is detected, the collision protection device 142 may eject the gel- or foam-like material to envelope the occupant. The gel- or foam-like material acts as a cushion that shields that occupant during the collision. The controller 116 is further configured to control the collision protection device 142 to operate upon detecting the impact of the collision.

In a preferred embodiment, the stroller system of the present invention further comprises a GPS unit 144 to determine a current location of the stroller system. The controller 116 is further configured to control the air circulating device 130 based on the current location of the stroller system. Specifically, the air circulating device 130 may be controlled based on the weather conditions of the detected current location.

In one embodiment, the stroller system of the present invention further comprising an ambient light sensor 146 disposed on the stroller frame 102. The stroller system of the present invention may also be equipped with a plurality of exterior lights 148. The plurality of exterior lights 148 may be controlled manually or remotely. Preferably, the controller 116 is further configured to turn on or off the plurality of exterior lights 148 according to a measurement result of the ambient light sensor 146. The plurality of exterior lights 148 is preferably disposed adjacent to the front wheels. The plurality of exterior lights 148 is configured to assist the user to see the surroundings when using the present invention at nighttime or darker area.

In one embodiment, the stroller system of the present invention further comprising a canopy 108 disposed on the stroller seat 106. As mentioned above, the canopy 108 may be fully closed to enclose the compartment for the occupant. The stroller system of the present invention further comprises a touch sensitive screen 150 placed underneath the canopy 108. The occupant may interact with the touch sensitive screen 150 as he or she learns from the video being shown.

The stroller system of the present invention may further comprise one or more storage compartments to allow the user to store diapers or other baby items.

Although the disclosure has been explained in relation to its preferred embodiment, it is to be understood that many other possible modifications and variations can be made without departing from the spirit and scope of the disclosure.

What is claimed is:

1. A stroller system comprising:
a stroller frame;
a plurality of wheels connected to the stroller frame;
a stroller seat attached to the stroller frame;
a motor mounted on the stroller frame and configured to drive at least one of the plurality of wheels;
a power source configured to supply power to the motor; and
a controller configured to control the and thereby the movement of the stroller system.

2. The stroller system as claimed in claim 1, further comprising:
a generator connected to the plurality of wheels;
the generator is further connected to the power source to recharge the power source.

3. The stroller system as claimed in claim 1, further comprising a pressure sensor positioned on a bottom portion of the stroller seat.

4. The stroller system as claimed in claim 3, further comprising a humidity sensor positioned on a sidewall portion of the stroller seat to detect an interior humidity of the stroller seat.

5. The stroller system as claimed in claim 4, further comprising a temperature sensor positioned on the sidewall portion of the stroller seat to detect an interior temperature of the stroller seat.

6. The stroller system as claimed in claim 5, further comprising:
an air circulating device positioned on the sidewall portion of the stroller seat;
the air circulating device being configured to circulate cool or hot air into the stroller seat.

7. The stroller system as claimed in claim 6, wherein the controller is further configured to control the air circulating device based on at least one of measurement results of the pressure sensor, humidity sensor, and temperature sensor.

8. The stroller system as claimed in claim 3, further comprising a plurality of interior lights positioned on the sidewall portion of the stroller seat.

9. The stroller system as claimed in claim 8, wherein the controller is further configured to control the plurality of interior lights according to a measurement result of the pressure sensor.

10. The stroller system as claimed in claim 1, further comprising an impact sensor for detecting an impact of a collision

11. The stroller system as claimed in claim 10, further comprising a collision protection device disposed in the stroller seat.

12. The stroller system as claimed in claim 11, the controller is further configured to control the collision protection device to operate upon detecting the impact of the collision.

13. The stroller system as claimed in claim 6, further comprising a GPS unit to determine a current location of the stroller system.

14. The stroller system as claimed in claim 13, wherein the controller is further configured to control the air circulating device based on the current location of the stroller system.

15. The stroller system as claimed in claim 1, further comprising an ambient light sensor disposed on the stroller frame.

16. The stroller system as claimed in claim 15, further comprising:
a plurality of exterior lights;
the controller being further configured to turn on or off the plurality of exterior lights according to a measurement result of the ambient light sensor.

17. The stroller system as claimed in claim 1, further comprising:
a canopy disposed on the stroller seat; and
a touch sensitive screen placed underneath the canopy.

18. The stroller system as claimed in claim 1, wherein the controller comprises a processor and a wireless communication unit.
